(19) United States
(12) Patent Application Publication
(10) Pub. No.: US 2026/0092619 A1
(43) Pub. Date: Apr. 2, 2026

(54) ADJUSTABLE HEADBOARD BRACKET

(71) Applicant: FLEXISPOT INC., Irvine, CA (US)

(72) Inventors: Lehong XIANG, Irvine, CA (US); Haojie ZHENG, Irvine, CA (US); Zhengjun CHEN, Irvine, CA (US); Lili WANG, Irvine, CA (US)

(21) Appl. No.: 19/272,735

(22) Filed: Jul. 17, 2025

(30) Foreign Application Priority Data
Sep. 30, 2024 (CN) 202411378785.6
Sep. 30, 2024 (CN) 202422406756.8

(51) Int. Cl. F16B 12/56; A47C 19/02; A47C 19/04

(52) U.S. Cl. CPC F16B 12/56; A47C 19/022; A47C 19/04

(57) ABSTRACT

An adjustable headboard bracket includes a stationary bracket, a movable bracket rotatably connected to the stationary bracket, a linear actuator, at least one connecting member and a guiding mechanism. The stationary bracket includes at least one sheet metal member, the sheet metal member can be arranged along a width direction or a length direction of the adjustable headboard bracket. The connecting member includes a connecting portion and a mounting portion, the mounting portion is connected to a first end of the connecting portion and can be mounted to an existing bed frame, a second end of the connecting portion is slidably connected to the sheet metal member along a length direction of the sheet metal member. The guiding mechanism is connected between the connecting portion and the sheet metal member, and the connecting portion and the sheet metal member can rotate relative to each other around the guiding mechanism.

### CROSS-REFERENCE TO RELATED APPLICATIONS

This present application claims the priorities of Chinese Patent Application No. 202411378785.6 filed to China National Intellectual Property Administration on Sep. 30, 2024, Chinese Patent Application No. 202422406756.8 filed to China National Intellectual Property Administration on Sep. 30, 2024, which are hereby incorporated by reference in their entireties.

### TECHNICAL FIELD

The present application relates to the field of furniture, and in particular to an adjustable headboard bracket.

### BACKGROUND

The adjustable bed of the related technology can adjust the user's sleeping, lying, sitting and other postures to relieve fatigue, so it is deeply loved by users. In order to make the ordinary bed in the user's home also have the adjustment functions of the adjustable bed, people install an adjustable support device under the mattress of the ordinary bed. Such adjustable support device is an independent component and also called an adjustable headboard bracket or an adjustable half bed. The user only needs to place the adjustable support device on an ordinary bed frame under the mattress. By rotating some parts of the adjustable support device, the height and tilt angle of the soft mattress above the adjustable support device can be adjusted, so that the mattress of the ordinary bed has the functions of height adjustment and tilt angle adjustment.

This type of adjustable headboard bracket in the related technology generally includes a stationary bracket and a backrest bracket. The stationary bracket is placed on the ordinary bed frame and is located on the side closer to the head of the bed. One end of the backrest bracket is rotatably connected to one end of the stationary bracket through a rotating shaft, which can enable the backrest bracket to rotate around the rotating shaft relative to the stationary bracket. A linear actuator is arranged between the stationary bracket and the backrest bracket, and one end of the linear actuator is hinged to the stationary bracket, and the other end of the linear actuator is hinged to the backrest bracket, so that the linear actuator can drive the backrest bracket to rotate and support the load-bearing capacity of the backrest bracket.

When purchasing this type of adjustable headboard bracket, users need to accurately measure the width of the existing bed frame, that is, the distance between the two inner walls of the bed frame along the width direction of the bed frame, and then choose an adjustable headboard bracket that matches the size. The size of the adjustable headboard bracket is mostly designed according to the size of the standard width bed, for example the width is set to 0.9 meters and 1.2 meters to match the single bed, and the width is set to 1.5 meters, 1.8 meters and 2 meters to match the double bed. But inevitably, for special-sized or non-standard-sized beds or custom-sized beds, the adjustable headboard bracket purchased by users often cannot be well adapted to the bed frame. Even if it can be placed on the bed frame, there is a large movable gap in the width direction of the bed frame, which poses a safety hazard. In order to better adapt to the width of existing bed frames, people have set the adjustable headboard bracket to be adjustable in width, such as the device disclosed in the patent application with publication number CN106954973A, whose width is adjustable, and the adjustable headboard bracket includes a long sheet metal member and a connecting portion, where the sheet metal member is connected to the outer frame of the bed frame, one end of the connecting portion is an insertion portion, and its shape is set to be able to be inserted into the sheet metal member and slide therein, and the other end has a mounting portion for mounting the bracket to the outer frame. The outer frame of the existing bed frame of different widths can be adapted by adjusting the distance of the connecting portion relative to the sheet metal member and a bolt assembly is threadedly connected to the sheet metal member and the inner end of the bolt assembly presses against the insertion part of the connecting portion to lock the connecting portion. Another common style of the adjustable headboard bracket with adjustable bed frame width on the market, whose bolt assembly passes through the sheet metal member and the connecting portion in turn and is then locked by a nut.

The above-mentioned adjustable headboard bracket with adjustable width size in the related art has the following defects in the installation process. Before installation, the user needs to measure the width of the existing bed frame first, then loosen the bolt assembly of the adjustable headboard bracket and adjust the connecting portion to a suitable extension length, and then tighten the bolt assembly, and finally install the adjustable headboard bracket on the existing bed frame. However, due to the inevitable measurement error and the position error of the connecting portion, it is often difficult to directly adapt the width of the adjustable headboard bracket accurately to the width of the existing bed frame or to install it accurately in place at one time. This causes a gap left after the user finally sets up the adjustable headboard bracket on the existing bed frame as above process and to eliminate the gap will require multiple adjustments which is troublesome and laborious. Specifically, if the extension length of the connecting portion is adjusted directly on the outer bed frame to adapt to the width of the existing bed frame after the adjustable headboard bracket is place on the existing bed frame, due to the weight of the adjustable headboard bracket, a large friction will be generated between the connecting portion and the sheet metal member, so it is difficult to pull out the connecting portion, and at least an additional person is required to lift the adjustable headboard bracket to reduce the friction, which makes the operation troublesome and laborious. Furthermore, the inner end of the bolt assembly is used to tighten the insertion part to lock the connecting portion. Since the contact area between the inner end of the bolt assembly and the insertion part of the connecting portion is small, the stability of the locking of the connecting portion is poor. Especially in the process of raising and lowering the adjustable headboard bracket, there will be a high potential of locking failure between the bolt assembly and the connecting portion, causing safety hazards. In addition, for the style of the adjustable headboard bracket where the bolt assembly passes through the sheet metal and the connecting portion in sequence and then is locked with a nut, since the bolt assembly has the functions of locking the extended length of the connecting portion and bearing the weight of the bed frame, after adjusting the extended length of the connecting portion directly on the outer bed frame, when tightening the bolt assembly, at least an additional person is required to lift the adjustable headboard bracket to reduce the influence of the adjustable headboard bracket's own gravity, otherwise it is difficult to tighten the bolt assembly to lock the connecting portion.

### SUMMARY

The present application provides an adjustable headboard bracket, including:
a stationary bracket, which includes at least one sheet metal member, the sheet metal member being configured to be arranged along a width direction or a length direction of the adjustable headboard bracket;
a movable bracket, which is rotatably connected to the stationary bracket;
a linear actuator configured to drive the movable bracket to rotate relative to the stationary bracket, the linear actuator connecting the movable bracket and the stationary bracket;
at least one connecting member, the connecting member including a connecting portion and a mounting portion, the mounting portion being connected to a first end of the connecting portion and configured to be mounted to an existing bed frame, a second end of the connecting portion being slidably connected to the sheet metal member along a length direction of the sheet metal member, the connecting portion being configured to adjust a distance between the mounting portion and the sheet metal member;
a guiding mechanism, which is connected between the connecting portion and the sheet metal member, and the connecting portion and the sheet metal member being configured to rotate relative to each other around the guiding mechanism.

In one embodiment, the adjustable headboard bracket further includes two supporting portions, wherein the two supporting portions are arranged respectively on an upper side and a lower side of the sheet metal member along the length direction of the sheet metal member, the two supporting portions are connected to one of the connecting portion and the sheet metal member, and the two supporting portions are configured to abut against a left one of the connecting portion and the sheet metal member when a gravity of the adjustable headboard bracket is loaded onto the existing bed frame.

In one embodiment, the guiding mechanism is arranged in a horizontal direction, the guiding mechanism includes a locking rod assembly connected to the connecting portion, and a guiding hole disposed at the sheet metal member extends along a length direction of the sheet metal member, and the locking rod assembly passes through the guiding hole.

In one embodiment, the guiding mechanism is arranged in a horizontal direction, the guiding mechanism includes a locking rod assembly connected to the sheet metal member, and a guiding hole disposed at the connecting portion extends along a length direction of the connecting portion, and the locking rod assembly passes through the guiding hole.

In one embodiment, the connecting portion is slidably mounted around a free end of the sheet metal member, the two supporting portions include a first supporting plate and a second supporting plate, the first supporting plate is connected to the second end of the connecting portion and the first supporting plate is in a sliding cooperation with a top of the sheet metal member, and the second supporting plate is connected to the first end of the connecting portion and the second supporting plate is in a sliding cooperation with a bottom of the sheet metal member.

In one embodiment, the first supporting plate, the second supporting plate and the connecting portion are integrally formed by a bent metal plate.

In one embodiment, the connecting portion is slidably sleeved in an internal cavity of the sheet metal member, the two supporting portions include a first supporting block and a second supporting block, the first supporting block is connected to and protrudes downwards from a bottom of the second end of the connecting portion, the first supporting block is in a sliding cooperation with internal walls of the sheet metal member, the second supporting block is connected to and protrudes upwards from a top of the first end of the connecting portion, the second supporting block is in a sliding cooperation with internal walls of the sheet metal member.

In one embodiment, the connecting portion is slidably sleeved in an internal cavity of the sheet metal member, the two supporting portions include a first supporting element and a second supporting element, the first supporting element is connected to and protrudes upwards from an internal bottom wall of the sheet metal member, the first supporting element is in a sliding cooperation with a bottom of the connecting portion, the second supporting element is connected to and protrudes downwards from an internal top wall of the sheet metal member, the second supporting element is in a sliding cooperation with a top of the connecting portion, and the first supporting element is further away from the mounting portion than the second supporting element.

In one embodiment, the sheet metal member is a hollow tube with a circular or a square cross section; or the sheet metal member is a groove-shaped member.

In one embodiment, the adjustable headboard bracket includes a plurality of sheet metal members, and two connecting members are respectively arranged on opposite sides along a length direction of each sheet metal member.

In one embodiment, a connecting end of the stationary bracket is connected to a supporting frame extending downwards and inclined towards a free end of the stationary bracket, and a mounting point is formed on the supporting frame; the linear actuator includes an actuator body and a driving end that reciprocates axially relative to the actuator body, the driving end is rotatably connected to one of the movable bracket and the mounting point, and the actuator body is rotatably connected to a left one of the movable bracket and the mounting point.

Other features and advantages of the present application will become apparent from the following detailed description of exemplary embodiments of the present application with reference to the accompanying drawings.

### BRIEF DESCRIPTION OF THE DRAWINGS

A brief description of drawings, which are incorporated in the description of embodiments, will be provided below to illustrate technical solutions of the present application clearly. Obviously, the drawings described below are merely some embodiments of the present application. For those skilled in the art, other drawings can be obtained based on these drawings without making inventive efforts.

FIG. 1 is a schematic structural diagram of an adjustable headboard bracket according to some embodiments of the present application.

FIG. 2 is a schematic structural diagram of the adjustable headboard bracket viewed from another angle according to some embodiments of the present application.

FIG. 3 is a side view of the adjustable headboard bracket according to some embodiments of the present application.

FIG. 4 is a schematic structural diagram of a connecting portion according to some embodiments of the present application.

FIG. 5 is a schematic structural diagram of the connecting portion viewed from another angle according to some embodiments of the present application.

FIG. 6 is a schematic diagram of an assembled connecting portion according to some embodiments of the present application.

FIG. 7 is a schematic structural diagram of the assembled connecting portion viewed from another angle according to some embodiments of the present application.

FIG. 8 is a schematic cross-sectional view of the assembled connecting portion according to some embodiments of the present application.

FIG. 9 is an exploded schematic structural diagram of another connecting portion according to some embodiments of the present application.

FIG. 10 is a exploded schematic structural diagram of FIG. 8.

FIG. 11 is a schematic cross-sectional view of FIG. 8.

FIG. 12 is a schematic cross-sectional view of another connecting portion according to some embodiments of the present application.

FIG. 13 is a schematic structural view of another assembled connecting portion according to some embodiments of the present application.

FIG. 14 is a schematic structural view of another assembled connecting portion according to some embodiments of the present application.

### DETAILED DESCRIPTION

First, those skilled in the art should understand that the implementations are only used to explain the embodiments of the present application, and are not intended to limit the protection scope of the embodiments of the present application. Those skilled in the art can make adjustments to them as needed to adapt to specific application scenarios.

In the description of the embodiments of the present application, it should be noted that, unless otherwise clearly specified and limited, the terms “connected”, “connection” and the like should be understood in a broadest scope. For example, it can be a fixed connection, a detachable connection, or an integral connection; it can be a mechanical connection or an electrical connection; it can be directly connected or indirectly connected through an intermediate medium. For those in the art, the specific meanings of the above terms in the embodiments of the present application can be understood according to specific circumstances.

In the embodiments of the present application, unless otherwise clearly specified and limited, a first feature being “above” or “below” a second feature may mean that the first and second features are in direct contact, or the first and second features are in indirect contact through an intermediate medium. Moreover, a first feature being “above” a second feature may mean that the first feature is directly above or obliquely above the second feature, or simply means that the first feature is higher in level than the second feature. A first feature being “below” a second feature may mean that the first feature is directly below or obliquely below the second feature, or simply means that the first feature is lower in level than the second feature.

The present application is further described in detail below with reference to the drawings and specific embodiments.

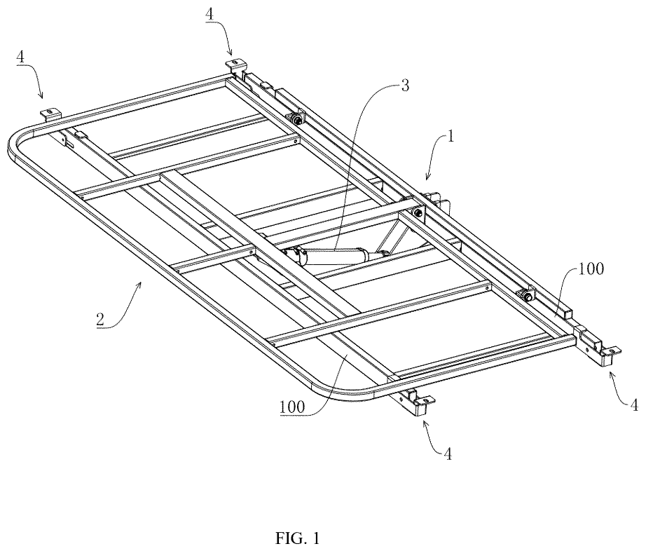

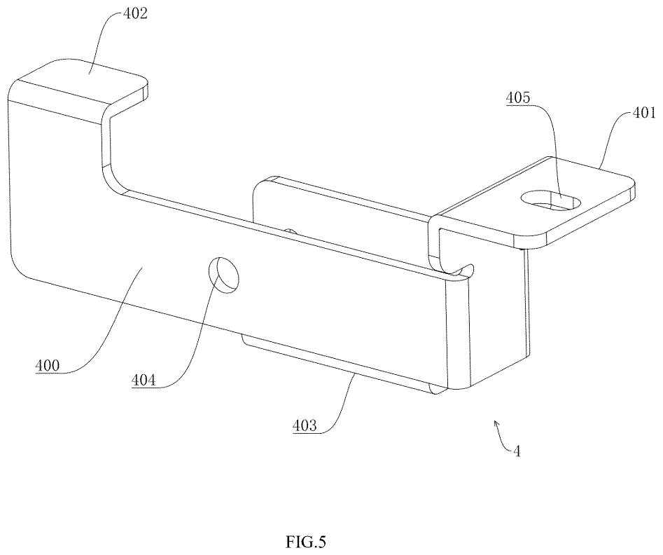

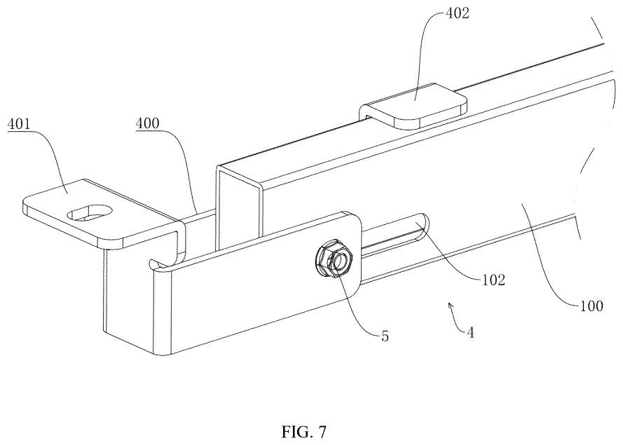

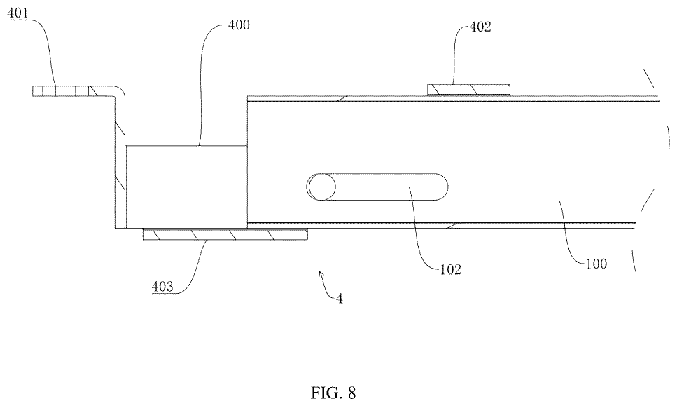

As shown in FIGS. 1 to 8, embodiments of the present application disclose an adjustable headboard bracket, which is configured to be mounted on a bed frame. The adjustable headboard bracket includes a stationary bracket 1, a movable bracket 2 and a linear actuator 3. The stationary bracket 1 is also called a stationary bed frame, or a bed base, etc., which is a square or rectangular structure welded by metal pipe fittings. The stationary bracket 1 is configured to be connected to an existing bed frame, and an end of the stationary bracket 1 away from a head of the bed is set as a connecting end. The movable bracket 2 is also called a movable bed frame, or a backrest frame, which is also a square or rectangular structure welded by metal pipe fittings. An end of the movable bracket 2 away from the head of the bed is rotatably connected to the connecting end of the stationary bracket 1 through a rotating shaft, so that the movable bracket 2 can rotate around an axis of the rotating shaft to adjust a tilt angle.

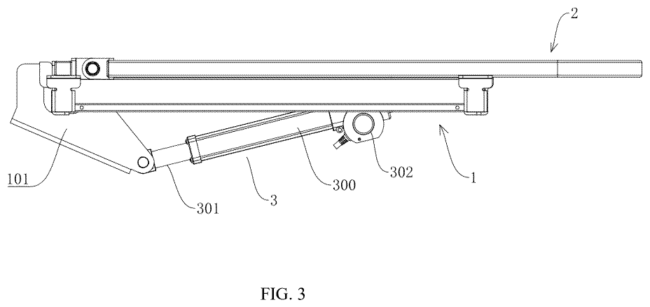

In some embodiments, as shown in FIG. 3, the linear actuator 3 connects the stationary bracket 1 and the movable bracket 2, and is configured to drive the movable bracket 2 to rotate relative to the stationary bracket 1 to adjust the tilt angle of the movable bracket 2. Specifically, the linear actuator 3 includes an actuator body 300 and a driving end 301 that axially reciprocates relative to the actuator body 300, and the actuator body 300 includes a driving motor 302 and a lead screw nut assembly that is transmission-connected to the driving motor 302. The driving end 301 is rotatably connected to the movable bracket 2, and the actuator body 300 is rotatably connected to the stationary bracket 1; or the actuator body 300 is rotatably connected to the movable bracket 2, and the driving end 301 is rotatably connected to the stationary bracket 1.

In order to provide sufficient push force when the movable bracket 2 rotates upward from the initial horizontal state, or to make a small push force from the linear actuator 3 enough to rotate the movable bracket 2 upward from the initial horizontal state, in some embodiments, a supporting frame 101 extending downwards and inclined towards a free end of the stationary bracket 1 is connected to the connecting end of the stationary bracket 1, and a mounting point is formed on the supporting frame 101. The linear actuator 3 can be rotatably connected to the mounting point. The arrangement of the supporting frame 101 forms a large tilt angle between an axis of the linear actuator 3 and a plane where the movable bracket 2 is located when the movable bracket 2 is in the initial horizontal state, so that a axial force of the linear actuator 3 can be more effectively converted into the push force for the movable bracket 2 to rotate upwards.

The linear actuator 3 in the above embodiments is a product of relatively mature technology in the prior art, which is used to convert a rotational motion of the drive motor 302 into the axial motion of the drive end 301. In other embodiments, the linear actuator 3 may also adopt an electric linear drive mechanisms such as a linear motor and an electric push rod.

In order to make the width of the stationary bracket 1 better match the width of the existing bed frame, and also facilitate the assembly of the adjustable headboard bracket with the existing bed frame, in some embodiments, as shown in FIGS. 1, 2, 7 and 8, the adjustable headboard bracket may further include at least one connecting member 4, and the stationary bracket 1 includes at least one sheet metal member 100, and the sheet metal member 100 may be arranged and extended along a width direction or/and a length direction of the adjustable headboard bracket. The connecting member 4 includes a connecting portion 400 and a mounting portion 401, and the mounting portion 401 is connected to a first end of the connecting portion 400 and configured to be mounted on the existing bed frame. A second end of the connecting portion 400 is slidably connected to the sheet metal member 100 along a length direction of the sheet metal member 100, and the connecting portion is configured to adjust a distance between the mounting portion 401 and the sheet metal member 100. When the sheet metal member 100 is arranged along the width direction of the adjustable headboard bracket, the connecting portion 400 can be mounted on a left side and a right side of the existing bed frame. When the sheet metal member 100 is arranged along the length direction of the adjustable headboard bracket, the connecting portion 400 can be mounted on a head side and a middle cross beam side of the existing bed frame.

With the above structural settings of the adjustable headboard bracket, the connecting member 4 can slide along the length direction of the sheet metal member 100, and the protruding length of the mounting portion 401 from the sheet metal member 100 can be adjusted to adapt to the width of the frame of the existing bed frame or/and a length measured from the head side and the middle cross beam side of the existing bed frame. Therefore, the connecting member 4 may be arranged on two opposite sides or any three or four sides of the stationary bracket 1, and the number of the connecting members 4 may be set according to actual needs.

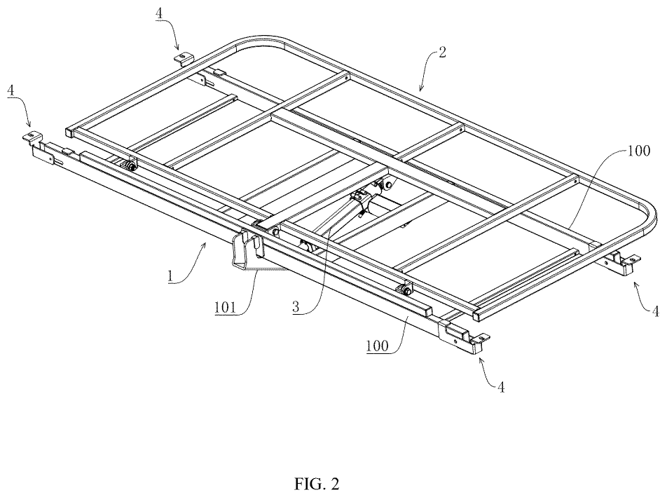

As shown in FIGS. 1 and 2, in some embodiments, the stationary bracket 1 includes two parallel long strip-shaped sheet metal members 100. The sheet metal members 100 may be metal square tubes. Two connecting members 4 are respectively arranged on opposite sides along a length direction of each sheet metal member 100, so four connecting members 4 are respectively connected to four ends of the two sheet metal members 100. When adapting to the existing bed frame, the four connecting members 4 can be pulled outwards respectively so that the mounting portions 401 of the connecting members 4 can be limited by abutting against the existing bed frame. Specifically, the mounting portions 401 may be placed at an inner position of the bed frame to allow the mounting portions 401 to abut against inner walls of the bed frame. Additionally, a mounting hole 405 may be disposed on each mounting portion 401 of each connecting member 4, and users can mount and fix the mounting portions 401 on the wooden bed frame by inserting connecting screws into the mounting holes 405.

With the above structural settings of the adjustable headboard bracket, the connecting portion 400 of the connecting member 4 can slide along the length direction of the sheet metal member 100, thus making the distance between the mounting portion 401 and the sheet metal member 100 adjustable. Therefore, the width of the stationary bracket 1 can be adjusted by adjusting the extended length of the connecting member 4, so that it can be adapted to the existing bed frames of different widths and has strong versatility.

When users mount the adjustable headboard bracket of the present application on the existing bed frame, there is no need to accurately compare the widths or lengths of the two. Users only need to place the adjustable headboard bracket directly and horizontally on the existing bed frame, and then pull the mounting portion 401 of the connecting member 4 outward until it abuts against the existing bed frame and fixes it to the existing bed frame. By finishing above simple processes, the width of the stationary bracket 1 can better adapt to the width of the existing bed frame, and can effectively avoid the defect of the gap caused by the inadequate mounting. There is no need to adjust the extended length of the connecting member 4 many times, so the mounting can be simple and labor-saving.

It is understandable that after the adjustable headboard bracket is mounted on the existing bed frame, during a process of the height adjustment of the movable bracket 2 of the adjustable headboard bracket, the movable bracket 2 is rotated and raised upwards. When the users lean on the movable bracket 2, if the connection between the connecting member 4 and the sheet metal member 100 is not firm enough or the connection stability is not enough, such as the tightening method with abutting screws adopted by the background technology, which is of high potential of movement or loosening of the connecting member 4 and further shaking or overturning of the stationary bracket 1 and cause safety hazards. In order to keep the connecting member 4 firmly on the sheet metal member 100 and prevent the connecting member 4 from moving due to accidents. A guiding mechanism is connected between the connecting portion 400 of the connecting member 4 and the sheet metal member 100, and the connecting portion 400 and the sheet metal member 100 can rotate relative to each other around the guiding mechanism. That is, as the mounting portion 401 of the connecting member 4 extends outwards and is connected to the existing bed frame, the connecting portion 400 and the sheet metal member 100 rotate relative to each other around the guiding mechanism. Specifically, during the adjustment process, the connecting portion 400 and the sheet metal member 100 can slide relative to each other, and there is a clearance fit between the upper walls of the connecting portion 400 and the sheet metal member 100 and a clearance fit between the lower walls of the connecting portion 400 and the sheet metal member 100. When the connecting portion 400 is adjusted to a suitable position, the connecting portion 400 and the sheet metal member 100 rotate relative to each other around the guiding mechanism as the gravity of the adjustable headboard bracket is loaded onto the existing bed frame. As a result, the upper and lower walls between the connecting portion 400 and the sheet metal member 100 abut each other and the corresponding friction force caused by the abutments between the upper and lower can keep the relative position of the connecting portion 400 and the sheet metal member 100 locked.

In some embodiments, the adjustable headboard bracket further includes two supporting portions, which are arranged respectively on an upper side and a lower side of the sheet metal member along the length direction of the sheet metal member. The two supporting portions are connected to or arranged on one of the connecting portion and the sheet metal member, and the two supporting portions are configured to abut against a left one of the connecting portion and the sheet metal member when a gravity of the adjustable headboard bracket is loaded onto the existing bed frame. In some embodiments, the two supporting portions may be respectively connected to or arranged on the connecting portion and the sheet metal member. Additionally, each supporting portion may be a separate element connected to the connecting portion and the sheet metal member or may be integrally formed with the connecting portion and the sheet metal member.

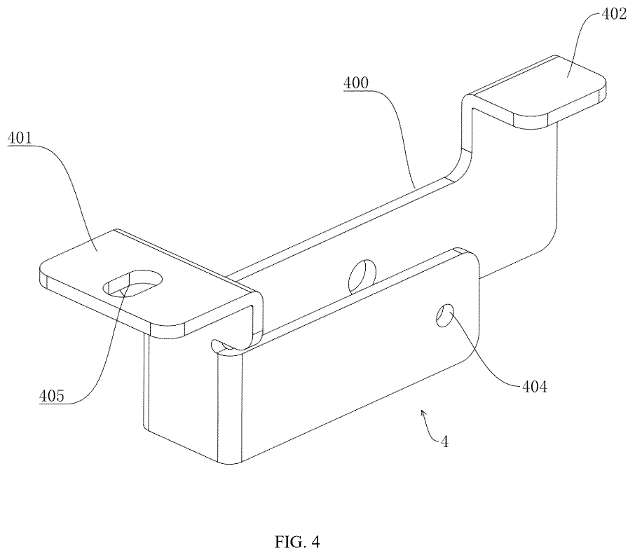

Specifically, as shown in FIGS. 4, 5, 6, 7 and 8, the two supporting portions are disposed in sequence along a length direction of the connecting portion 400 of the connecting member 4, and the two supporting portions are respectively located on an upper side and a lower side of the connecting portion 400 and respectively abut against the sheet metal member 100. Under the action of the gravity of the adjustable headboard bracket, the connecting portion 400 and the sheet metal member 100 abut against each other via the two supporting portions, and the corresponding friction force can keep the two locked at this relative position.

When the connecting member 4 is extended relative to the sheet metal member 100 and fixed to the existing bed frame, under the action of the gravity of the adjustable headboard bracket itself, the sheet metal member 100 applies downward pressure to the connecting member 4. Specifically, the bottom of the sheet metal member 100 applies pressure to the connecting member 4 via a lower supporting portion, and the connecting member 4 applies pressure to the top of the sheet metal 100 via an upper supporting portion. As the two supporting portions are staggered in the vertical direction, a locking effect between the connecting member 4 and the sheet metal member 100 can be generated. With the locking effect, friction forces can be generated between the sheet metal member 100 and the connecting member 4 at the two supporting portions, thereby realizing self-locking of the movement of the connecting portion 400.

Furthermore, under the action of the gravity of the adjustable headboard bracket itself, the connecting portion 400 and the sheet metal member 100 abut against each other via the two supporting portions, and the corresponding friction force can keep the two locked in the relative position. That is, under the action of the gravity of the adjustable headboard bracket itself, the corresponding friction force between the connecting portion 400 and the sheet metal member 100 can be generated at the two supporting portions and the locking effect can be generated along a non-sliding direction of the connecting portion 4. Such arrangements not only make the connecting portion 4 more firmly, stably and safely locked, but also effectively reduces the contact area between the connecting portion 400 and the sheet metal member 100 to make it easier that the connecting portion 4 can be pulled out without totally lifting the adjustable headboard bracket, making the entire mounting process simple and labor-saving.

It can be understood that the supporting portions act as abutment points, which can be the supporting structures of point-shape, block-shape, plate-shape or rod-shaped, where the supporting structures of point-shape may be understood as convex points, or the two contacting points between an inner structure and an outer structure sleeved on the inner structure without any additional convex structure. Under the action of the adjustable headboard bracket's own gravity, friction forces generated at the two contacting points can generate friction on the sheet metal member 100 to keep the connecting member 4 locked in the relative position.

In some embodiments, as shown in FIGS. 4, 5, 6, 7 and 8, the connecting portion 400 of the connecting member 4 is slidably mounted around a free end of the sheet metal member 100. The two supporting portions include a first supporting plate 402 and a second supporting plate 403. The first supporting plate 402 is connected to the second end of the connecting portion 400 and the first supporting plate 402 is in a sliding cooperation with a top of the sheet metal member 100. The second supporting plate 403 is connected to the first end of the connecting portion 400 and the second supporting plate 403 is in a sliding cooperation with a bottom of the sheet metal member 100. The first supporting plate 402, the second supporting plate 403 and the connecting portion 400 may be integrally formed by a bent metal plate, and a channel for the sheet metal member 100 to pass through is formed between the first supporting plate 402 and the second supporting plate 403, and the structural stability of the connecting member 4 is good.

With the above arrangements, under the action of the adjustable headboard bracket's own gravity, the sheet metal member 100 abuts against the connecting member 4 via the first supporting plate 402 and the second supporting plate 403. In other words, under the pressure of the sheet metal member 100, the second supporting plate 403 applies an upward reaction force to the sheet metal member 100, and under the pressure of the sheet metal member 100, the first supporting plate 402 applies a downward reaction force to the sheet metal member 100. Therefore, the reaction forces applied by the second supporting plate 403 and the first supporting plate 402 to the sheet metal member 100 are in opposite directions, and the two reaction forces form a non-collinear locking effect, which can well keep the connecting member 4 on the sheet metal member 100.

In some embodiments, in order to make the connecting member 4 more firmly held on the sheet metal member 100 and prevent the connecting member 4 from moving accidentally, the guiding mechanism is connected between the connecting portion 400 and the sheet metal member 100, which can lock the connecting portion 400 at any position of its travel. The guiding mechanism is arranged in the horizontal direction. That is, when the mounting portion 401 of the connecting member 4 extends outward and connects to the existing bed frame, the guiding mechanism can be locked, so that the connecting member 4 is locked on the sheet metal member 100, thereby improving the safety of use.

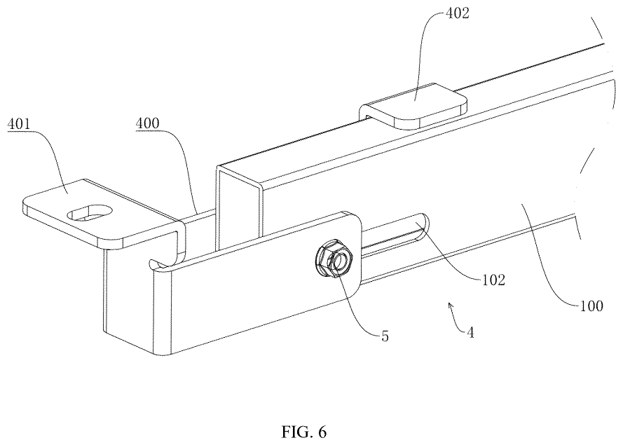

The guiding mechanism can be locked by fasteners, or can be locked by buckles or other limiting structures such as snap-fitting slots, cam pressing mechanisms. to lock the connecting member 4 on the sheet metal member 100. As shown in FIG. 6, the guiding mechanism includes a locking rod assembly 5 connected to the connecting portion 400. A guiding hole 102 disposed on the sheet metal member 100 extends along a length direction of the sheet metal member, and the locking rod assembly 5 passes through the guiding hole 102. Specifically, the locking rod assembly 5 includes a locking rod with threads and a nut threadedly connected to a threaded portion of the locking rod. The connecting portion 400 is provided with a connecting hole 404 extending along the horizontal direction, and the locking rod sequentially passes through the connecting hole 404 and the guiding hole 102 and is threadedly connected to the nut. The locking or unlocking of the connecting member 4 can be achieved by tightening or loosening the nut.

With the above arrangements, the locking rod assembly 5 not only has a function of locking the connecting member 4 and the sheet metal member 100, but also has a function of guiding and labor-saving. Specifically, the locking rod assembly 5 passes through the guide hole 102 with the locking rod assembly 5 and the guide hole 102 arranged in the horizontal direction rather than the vertical direction. That is, the locking force applied by the locking rod assembly 5 and the friction force at the two supporting portions don't share a same line. When the connecting member 4 slides relative to the sheet metal member 100, the sliding cooperation between the locking rod assembly 5 and the guide hole 102 plays a guiding role, making the sliding of the connecting member 4 smoother. When the gravity of the adjustable headboard bracket is loaded onto the existing bed frame and the users want to adjust the extension of the connecting portion 400, the users only need to apply a rotational force to make the connecting portion 400 and the sheet metal member 100 rotate relative to each other around the guiding mechanism with the locking rod serving as a pivot, thus unlocking the connecting member 4 and the sheet metal member 100. Compared to the lifting force needed of the background technology in the same situation to unlock the connecting member 4 and the sheet metal member 100, the rotational force is much smaller.

It is not difficult to understand that when the adjustable headboard bracket is directly placed horizontally on the existing bed frame for mounting, the first supporting plate 402 and the second supporting plate 403 form two supporting points to apply a non-collinear locking effect between the connecting member 4 and the sheet metal member 100, so that the gravity of the adjustable headboard bracket is only applied to the connecting member 4 through the sheet metal member, and the locking rod assembly 5 is almost completely free of the pressure. Therefore, the locking rod assembly 5 only plays the role of locking the extended length of the connecting member 4. When tightening the locking rod assembly 5, only a small external force is required to eliminate the influence of the adjustable headboard bracket's own gravity on the locking rod assembly 5, so that the users can adjust it easily and with less effort. There is no need to worry about the sheet metal member 100 moving accidentally during the process of tightening the locking rod assembly 5. Therefore, the operation is simple and labor-saving, and the structural failure problem cannot be easily caused by the improper installation of the locking rod assembly 5, so that the locking rod assembly 5 can be tightened more firmly and stably, and the safety of the structure can be improved.

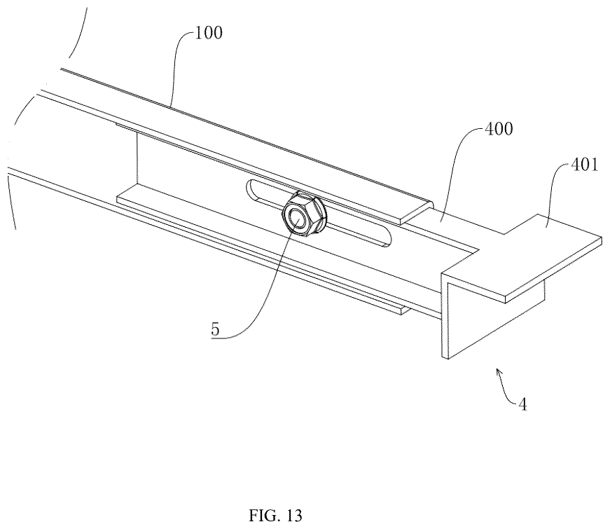

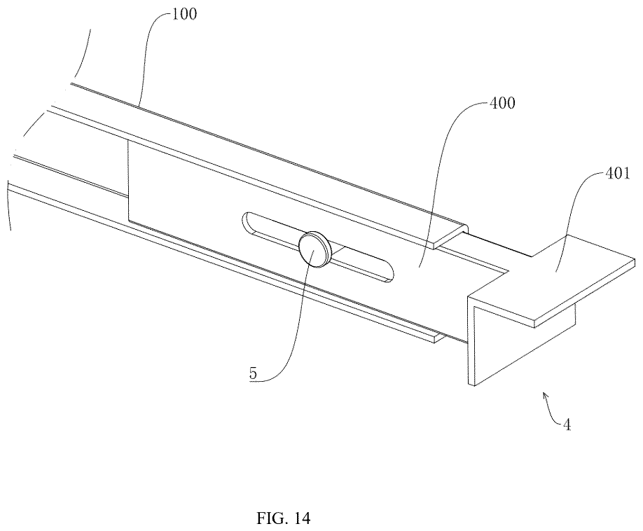

In some embodiments, the locking rod assembly 5 of the guiding mechanism may be connected to the sheet metal member 100, and the guiding hole 102 extending along the length direction is provided on the connecting portion 400. The locking rod assembly 5 passes through the guiding hole, as shown in FIGS. 13 and 14. In other words, the positions of the locking rod assembly 5 and the guiding hole 102 can be exchanged between the sheet metal member 100 and the connecting member 4.

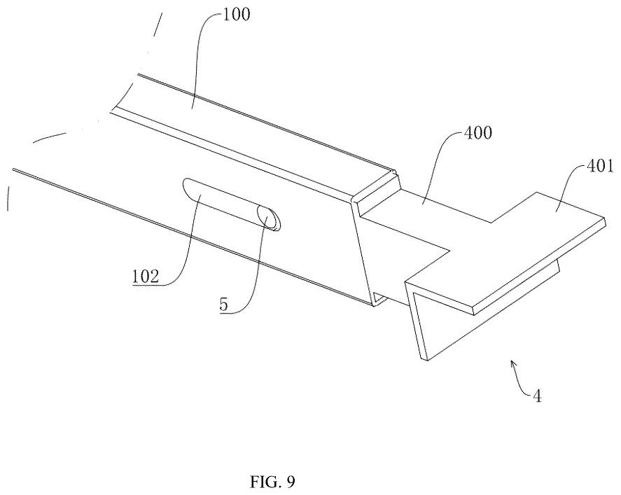

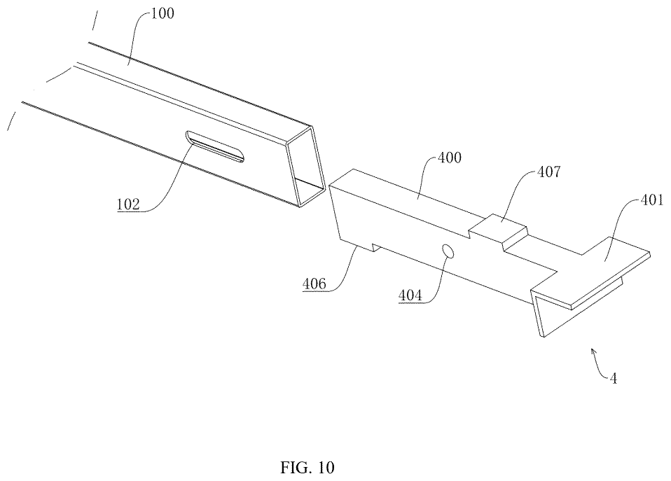

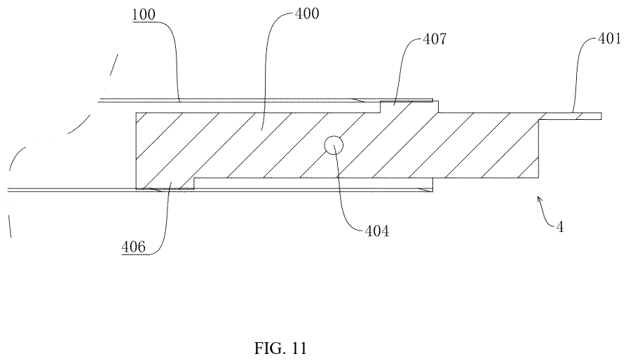

In some embodiments, as shown in FIGS. 9, 10 and 11, the sheet metal member 100 may be a hollow tube with a square cross section and the connecting portion 400 is slidably sleeved in an internal cavity of the sheet metal member 100. The two supporting portions include a first supporting block 406 and a second supporting block 407. The first supporting block 406 is connected to and protrudes downwards from a bottom of the second end of the connecting portion 400, and the first supporting block 406 is in a sliding cooperation with internal walls of the sheet metal member 100. The second supporting block 407 is connected to and protrudes upwards from a top of the first end of the connecting portion 400, the second supporting block 407 is in a sliding cooperation with internal walls of the sheet metal member 100. Under the action of the adjustable headboard bracket's own gravity, the sheet metal member 100 abuts against the connecting member 4 via the first supporting block 406 and the second supporting block 407. In other words, under the pressure of the sheet metal member 100, the second supporting block 407 applies an upward reaction force to the sheet metal member 100, and under the pressure of the sheet metal member 100, the first supporting block 406 applies a downward reaction force to the sheet metal member 100. Therefore, the reaction forces applied by the second supporting block 407 and the first supporting block 406 to the sheet metal member 100 are in opposite directions, and the two reaction forces form a non-collinear locking effect, which can well keep the connecting member 4 in the sheet metal member 100. Such arrangements reduce the contact area between the connecting portion 400 and the sheet metal member 100 to make it easier that the connecting portion 4 can be pulled out without totally lifting the adjustable headboard bracket, making the entire mounting process simple and labor-saving.

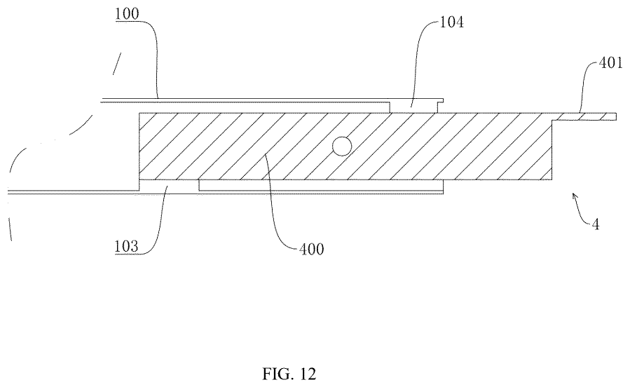

In some embodiments, two supporting portions may be disposed on the sheet metal member 100. For example, the two supporting portions are disposed in sequence along the length direction of the sheet metal member 100, and the two supporting portions are respectively located at the upper and lower sides of the sheet metal member 100 and respectively abut against the connecting portion 400. Specifically, as shown in FIG. 12, the sheet metal member 100 is a hollow tube with a square cross section and the connecting portion 400 is slidably sleeved in an internal cavity of the sheet metal member. The two supporting portions include a first supporting element 103 and a second supporting element 104. The first supporting element 103 is connected to and protrudes upwards from an internal bottom wall of the sheet metal member 100, and the first supporting element 103 is in a sliding cooperation with a bottom of the connecting portion 400. The second supporting element 104 is connected to and protrudes downwards from an internal top wall of the sheet metal member 100, the second supporting element 104 is in a sliding cooperation with a top of the connecting portion 400. The first supporting element 103 is further away from the mounting portion 401 than the second supporting element 104. The reaction forces applied by the first supporting element 103 and the second supporting element 104 to the connecting member 4 are in opposite directions, and the two reaction forces form a non-collinear locking effect, which can well keep the connecting member 4 in the sheet metal member 100.

The sheet metal member 100 in the above embodiment is generally configured as a hollow sleeve tube, and its cross section may be circular or square.

In some embodiments, the sheet metal member 100 may be a groove-shaped member, such as a square channel steel structure, an I-beam structure, etc. The connecting member 4 may also be a groove-shaped member or a metal square tube which can be sleeved and relatively slid therewith. As shown in FIG. 13, the cross-sections of the sheet metal member 100 and the connecting member 4 are both configured as square groove-shaped members. As shown in FIG. 14, the cross-sections of the sheet metal member 100 are configured as square groove-shaped member, and the connecting member 4 is configured as a metal square tube, which is slidably sleeved in the sheet metal member 100.

In the description of the embodiments of the present application, it should be noted that in the description of the present application, terms such as “inside” and “outside” indicating directions or positional relationships are based on the directions or positional relationships shown in the drawings. This is only for the convenience of description, and does not indicate or imply that the device or component must have a specific orientation, be constructed and operated in a specific orientation. Therefore, it cannot be understood as a limitation on the present application.

In the description of the present application, the description with reference to the terms “one embodiment”, “some embodiments”, “implementation”, “example”, or “specifically”. means that the specific features, mechanisms, materials or characteristics described in conjunction with the embodiment or example are included in at least one embodiment or example or implementation of the present application. In this specification, the schematic representations of the above terms do not necessarily refer to the same embodiment or example or implementation. Moreover, the specific features, mechanisms, materials or characteristics described may be combined in a suitable manner in any one or more embodiments or examples. In addition, those skilled in the art may combine the different embodiments or examples described in this specification and the features of the different embodiments or examples, without contradiction.

The above are only some specific implementations of the present application, but the protection scope of the present application is not limited thereto. Any changes or substitutions that can be easily thought of by a person skilled in the art within the technical scope disclosed in the present application should be included in the protection scope of the present application. Therefore, the protection scope of the present application shall be based on the protection scope of the claims.

What is claimed is:

1. An adjustable headboard bracket, comprising:
a stationary bracket, which comprises at least one sheet metal member, the sheet metal member being configured to be arranged along a width direction or a length direction of the adjustable headboard bracket;
a movable bracket, which is rotatably connected to the stationary bracket;
a linear actuator configured to drive the movable bracket to rotate relative to the stationary bracket, the linear actuator connecting the movable bracket and the stationary bracket;
at least one connecting member, the connecting member comprising a connecting portion and a mounting portion, the mounting portion being connected to a first end of the connecting portion and configured to be mounted to an existing bed frame, a second end of the connecting portion being slidably connected to the sheet metal member along a length direction of the sheet metal member, the connecting portion being configured to adjust a distance between the mounting portion and the sheet metal member;
a guiding mechanism, which is connected between the connecting portion and the sheet metal member, and the connecting portion and the sheet metal member being configured to rotate relative to each other around the guiding mechanism.

2. The adjustable headboard bracket according to claim 1, further comprising two supporting portions, wherein the two supporting portions are arranged respectively on an upper side and a lower side of the sheet metal member along the length direction of the sheet metal member, the two supporting portions are connected to one of the connecting portion and the sheet metal member, and the two supporting portions are configured to abut against a left one of the connecting portion and the sheet metal member when a gravity of the adjustable headboard bracket is loaded onto the existing bed frame.

3. The adjustable headboard bracket according to claim 1, wherein the guiding mechanism is arranged in a horizontal direction, the guiding mechanism comprises a locking rod assembly connected to the connecting portion, and a guiding hole disposed at the sheet metal member extends along the length direction of the sheet metal member, and the locking rod assembly passes through the guiding hole.

4. The adjustable headboard bracket according to claim 1, wherein the guiding mechanism is arranged in a horizontal direction, the guiding mechanism comprises a locking rod assembly connected to the sheet metal member, and a guiding hole disposed at the connecting portion extends along a length direction of the connecting portion, and the locking rod assembly passes through the guiding hole.

5. The adjustable headboard bracket according to claim 2, wherein the connecting portion is slidably mounted around a free end of the sheet metal member, the two supporting portions comprise a first supporting plate and a second supporting plate, the first supporting plate is connected to the second end of the connecting portion and the first supporting plate is in a sliding cooperation with a top of the sheet metal member, and the second supporting plate is connected to the first end of the connecting portion and the second supporting plate is in a sliding cooperation with a bottom of the sheet metal member.

6. The adjustable headboard bracket according to claim 5, wherein the first supporting plate, the second supporting plate and the connecting portion are integrally formed by a bent metal plate.

7. The adjustable headboard bracket according to claim 2, wherein the connecting portion is slidably sleeved in an internal cavity of the sheet metal member, the two supporting portions comprise a first supporting block and a second supporting block, the first supporting block is connected to and protrudes downwards from a bottom of the second end of the connecting portion, the first supporting block is in a sliding cooperation with internal walls of the sheet metal member, the second supporting block is connected to and protrudes upwards from a top of the first end of the connecting portion, the second supporting block is in aa sliding cooperation with internal walls of the sheet metal member.

8. The adjustable headboard bracket according to claim 2, wherein the connecting portion is slidably sleeved in an internal cavity of the sheet metal member, the two supporting portions comprise a first supporting element and a second supporting element, the first supporting element is connected to and protrudes upwards from an internal bottom wall of the sheet metal member, the first supporting element is in a sliding cooperation with a bottom of the connecting portion, the second supporting element is connected to and protrudes downwards from an internal top wall of the sheet metal member, the second supporting element is in a sliding cooperation with a top of the connecting portion, and the first supporting element is further away from the mounting portion than the second supporting element.

9. The adjustable headboard bracket according to claim 1, wherein the sheet metal member is a hollow tube with a circular or square cross section; or the sheet metal member is a groove-shaped member.

10. The adjustable headboard bracket according to claim 1, wherein the adjustable headboard bracket comprises a plurality of sheet metal members, and two connecting members are respectively arranged on opposite sides along the length direction of each sheet metal member.

11. The adjustable headboard bracket according to claim 1, wherein a connecting end of the stationary bracket is connected to a supporting frame extending downwards and inclined towards a free end of the stationary bracket, and a mounting point is formed on the supporting frame; the linear actuator comprises an actuator body and a driving end that reciprocates axially relative to the actuator body, the driving end is rotatably connected to one of the movable bracket and the mounting point, and the actuator body is rotatably connected to a left one of the movable bracket and the mounting point.
